(19) United States
(12) Patent Application Publication
(10) Pub. No.: US 2011/0157185 A1
(43) Pub. Date: Jun. 30, 2011

(54) METHOD FOR PATTERN FILE FORMATION FOR A DRIVING AND CONTROLLING SENSING ELEMENT OF AN ELECTRIC/ELECTRONIC DEVICE AND AN APPARATUS FOR A DRIVING AND CONTROLLING SENSING ELEMENT OF AN ELECTRIC/ELECTRONIC DEVICE USING PATTERN FILE

(76) Inventors: Koo-Young Song, Seoul (KR); Yuan-Chi Liu, Daegu (KR)

(21) Appl. No.: 13/061,196

(22) PCT Filed: Aug. 24, 2009
(86) PCT No.: PCT/KR2009/004709

§ 371 Date: Feb. 28, 2011

(30) Foreign Application Priority Data
Sep. 1, 2008 (KR) 10-2008-0085688

(51) Int. Cl. G06T 11/20

(52) U.S. Cl. 345/440

(57) ABSTRACT

A method for pattern file formation for driving and controlling the sensing element of an electric/electronic device and an apparatus for driving and controlling the sensing element of an electric/electronic device using the same, wherein an audio signal is called without playback to display, as a graph, a waveform of a visualized pattern file that has been generated without correction of the audio signal, so that a user can readily generate and correct the pattern file on a window screen; menus for preparing various pattern files are displayed; and it is made possible to apply a generated pattern file to the sensing element of an electric/electronic device using a variable voltage source, so that the light-emitting diode, vibration motor, actuator, and other sensing elements are driven and controlled either simultaneously or selectively, allowing the maximum sense of reality to be delivered to the user of the application program.

### BACKGROUND OF THE INVENTION

The present invention relates to a method for forming a pattern file from an audio signal by a user himself or herself, and an apparatus for simultaneously or selectively driving and controlling sensing elements of electric/electronic devices, such as light emitting diodes, vibration motors, actuators, and the like, using the pattern file.

With the advancement of information processing technologies including memory and sound technologies, users using various kinds of electric/electronic devices, such as MP3 players, cellular phones, game consoles, and the like, request these devices to provide further realistic interactions.

Accordingly, an interest in methods for providing software and hardware environments capable of further realistically delivering visual and haptic information, in addition to conventional auditory information, keeps on the rise.

Recently, LED driving apparatuses are proposed and used, in which a light emitting diode (hereinafter, referred to as “LED”), i.e., a visual element, is installed in various kinds of electric/electronic devices such as a game condole, a computer, or the like, as an example of sensing element, and the LED responds to the contents of a program while the program is used.

Generally, such a conventional LED driving apparatus entails a problem in that since it is controlled in such a fashion as to simply turning on and off the LEDs depending on existence or absence of a speaker output signal or a power signal, it is boring and bellyful to repetitively use the conventional LED driving apparatus for an extended period of time.

In addition, since such an apparatus responds to all the audio signals generated from a computer or a device, it is driven even by a process of turning on and off the apparatus or an unnecessary audio signal such as a noise or the like. Therefore, there is a problem in that the apparatus does not properly respond to sound effects of an actual game or an application, an audible feeling entirely different from the sounds of the game or the application is delivered to the users.

In response to such a demand, techniques for displaying an image such as a level meter or the like on a screen of a main body of a portable device for playing back music and varying the image in accordance with a genre or sounds of the music have been proposed recently. Korean Utility Model Registration No. 20-0364457 related to a technique for installing an LED in an accessory earphone-microphone and flashing the LED while a user is communicating voices or listening to music has been previously registered. However, since a flashing interval is simply set to a predetermined value, the LED does not flash in correspondence with the sound effects.

In addition, since conventional pattern files of a tactile device, such as a haptic device, are formed to be fit only for tactile sensing devices (e.g., vibration motors, actuators, and the like), there is a problem in that a relevant pattern file may not be used if it is applied to other applications of an electric/electronic device.

Moreover, since the conventional pattern files cannot provide users with a function of modifying and editing a pattern file as needed, the pattern files are not suitable for modern users who put stress on individuality.

In response to such a demand, the present applicant has proposed a technique for enabling keypads, touch screens, vibration motors, and LEDs to deliver a variety of visual and tactile information to users in various manners using generally used audio signals or pulse width modulation (PWM) signals, respectively corresponding to analog and digital signals, through a voltage source control apparatus and a variable voltage source drive and control apparatus disclosed in Korean Patent Registration No. 10-0757242.

In this case, however, electric/electronic devices to be applied with such a technique do not have a formalized development tool for finding optimum visual and tactile effects, and developers should estimate and put in various parameter values one by one. Therefore, procedures experienced by the developers are different from one another, and a lot of time and efforts are required.

### SUMMARY OF THE INVENTION

The present invention has been made to fulfill the above-mentioned consumers' desires, and it is an object of the present invention to easily form a pattern file from an audio signal by a user, selectively or simultaneously drive a plurality of sensing elements of an electric/electronic device, such as an LED, a vibration motor, an actuator and the like, using one pattern file formed by the user and a variable voltage source proposed by the present applicant in a previously registered patent, and drive the sensing elements included in the electric/electronic device to be accorded or harmonized with the audio signal or various application programs by adjusting a cycle or a size of a signal in accordance with or independently from a sound effect, thereby allowing the user to experience realistic feelings and elegance in executing a game or various applications.

To achieve the above objects, in one aspect, the present invention provides a method of forming a pattern file for driving and controlling sensing elements of an electric/electronic device, using a system which includes: all kinds of input means including a keyboard and mouse, a touch screen, a touch pad, and a keypad; a CPU for controlling various operations; a memory for recording various data; and a pattern file generating program module for generating the pattern file used for driving and controlling the sensing elements of the electric/electronic device using an audio signal depending on a control command of the CPU and an input signal of the input means, and storing the generated pattern file in the memory, the method including: a module driving step of allowing the CPU to drive the pattern file generating program module depending on the signal inputted through the input means; a display step of allowing the pattern file generating program module to display a waveform of the pattern file generated by analyzing the audio signal selected through the input means on a screen and simultaneously display a pattern modify menu (including options of an offset rate, an amplification rate, and a maximum power, a minimum power, a safe power, a duration sustaining safe or higher strength, and selection of a vibrating method according to the electric/electronic device); a modifying step of modifying a waveform graph of the pattern file in accordance with values changed on the pattern modify menu inputted through the input means, and displaying the modified waveform graph on the screen; and a recoding step of recoding the pattern file as modified above if the modification is completed.

The pattern file for driving and controlling the sensing elements of the electric/electronic device formed as described above is recorded in the memory where the data are recorded, and the pattern file can be transferred to other electric/electronic devices through a wired or wireless connection or a storage medium to be applied to the other electric/electronic devices

In another aspect, the present invention provides an apparatus for driving and controlling sensing elements of an electric/electronic device using a pattern file, the apparatus including: all kinds of input means including a keyboard, a mouse, a touch screen, a touch pad, a remote controller, a keypad, and the like; a game or various application execution module executed by a CPU of a main body when a command for executing a game or various applications is inputted through the input means and calling the pattern file from the memory in accordance with or independently from the audio signal; a sensing element drive and control CPU of the electric/electronic device for receiving a file including the pattern file outputted from the game or various application execution module and generating a PWM signal including data for identifying each sensing element of the electric/electronic device in order to drive and control a plurality of sensing elements of the electric/electronic device; and a variable voltage source circuit and sensing elements for driving and controlling corresponding sensing elements based on the data for identifying sensing elements of the electric/electronic device included in the control signal outputted from the sensing element drive and control CPU of the electric/electronic device.

In the configuration described above, the main body is an electric/electronic device or the like, such as a computer, a game console, a mobile communication terminal, a PDA, a DMB, a digital TV, an IP TV, a navigation device, an MP3 player, an MP4 player, or the like, and constitutional components of the apparatus for driving and controlling sensing elements of the electric/electronic device may be provided in the main body as one body, or some of the constitutional components are connected to the main body through a wired or wireless connection and provided as a peripheral device or an accessory, such as a keyboard, a mouse, a remote controller, an earphone, a headset, or the like.

The sensing elements uses one or more LEDs, a vibration motor, an actuator, a scent emitting device, and the like.

The control signal for driving the sensing elements is configured as a function including an on/off mode (in the case of a motor, used as a forward/reverse rotation mode), an operating level, and a driving time, and only one function needs to be used to drive the sensing elements.

The apparatus for driving and controlling sensing elements of an electric/electronic device may further include a switching unit between the variable voltage source and the sensing element as needed, and in this case, the sensing element drive and control CPU outputs a SEL signal, i.e., an operation selection signal of the switching unit, together with the PWM signal, in order to control outputs of a plurality of output terminals of the switching unit. The selection signal uses a value obtained by dividing a level by the number of controllable switches as an order.

The variable voltage source circuit includes a transistor having an input terminal for receiving an input voltage and an output terminal for outputting an output voltage, and an operational amplifier for controlling the transistor by comparing voltage levels of two input signals, in which a feedback circuit selectively varies a feedback ratio of a voltage fed back from the output terminal and applied to one input terminal of the operational amplifier, and a control input voltage corresponding to a control signal variable with time is applied to the other input terminal of the operational amplifier.

The present invention has an effect in that since a user can conveniently and easily generate a pattern file for driving and controlling light emission and vibration of an electric/electronic device using an audio signal or an external sound source in a Windows environment, realistic feelings and satisfactions can be maximized when the user executes a game or various applications.

Furthermore, since the pattern file generated as described above can control brightness using a variable voltage source, colors (RGB) of 3-color LEDs can be individually and finely controlled using one pattern file, and thus diverse and realistic visual effects can be obtained by combination of three colors.

Furthermore, since a direction of motion, a vibrating duration time, and vibration strength of a vibration motor or an actuator, i.e., tactile elements among sensing elements, are controlled, an optimum haptic effect can be obtained when a user executes a game or various applications.

### BRIEF DESCRIPTION OF THE DRAWINGS

FIG. 1 is a block diagram showing the configuration of an apparatus for driving an electric/electronic device using a pattern file according to the present invention.

FIGS. 2 to 5 are views showing an example of generating and modifying a pattern file.

FIG. 6 is a block diagram showing the configuration of a variable voltage source circuit unit according to the present invention.

FIG. 7 is a view showing a characteristic curve diagram of the variable voltage source circuit unit in FIG. 6.

FIG. 8 is a block diagram showing an example of a variable voltage source circuit unit driving 3-color LEDs.

FIGS. 9 and 10 are block diagrams showing an example of a variable voltage source circuit unit driving LEDs.

FIGS. 11 and 12 are block diagrams showing an example of a variable voltage source circuit unit driving a motor.

FIG. 13 is a view showing a sensing element drive and control unit provided in an electric/electronic device, such as a FDA, a cellular phone, or the like, as one body.

FIG. 14 is a view showing a sensing element drive and control unit connected to an electric/electronic device through a wired or wireless connection and provided as a device external to an earphone or a headset.

### DETAILED DESCRIPTION OF THE INVENTION

An embodiment of the present invention will be described below in more detail with reference to the accompanying drawings. In the embodiment of the present invention, LEDs (RGB 3-color LEDs) and an M (a vibration motor, an actuator which is a kind of motor performing upward/downward, forward/backward and linear motions, or the like) are used as sensing elements of an electric/electronic device, an external type of variable voltage source and sensing element drive and control apparatus is used, and a computer is used as a main body.

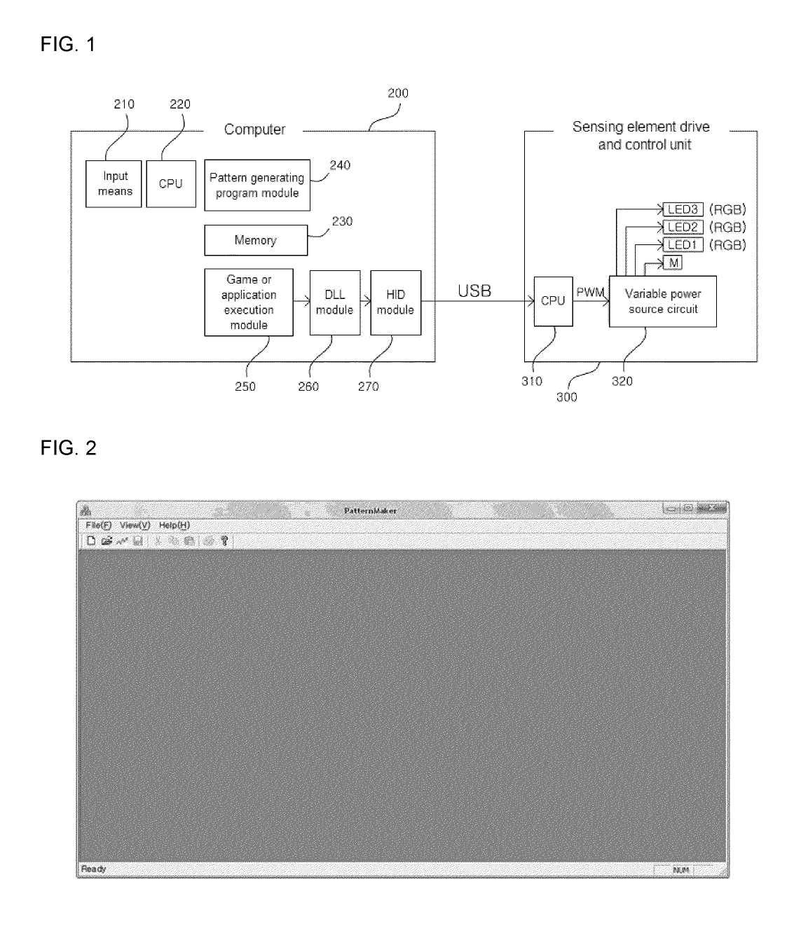

FIG. 1 is a block diagram showing the configuration of an electric/electronic device for generating a pattern file, and an apparatus for driving and controlling sensing element of the electric/electronic device using the pattern file according to the present invention.

An apparatus for driving and controlling sensing elements of an electric/electronic device according to the present invention includes a computer 200 for outputting control signals for driving a plurality of light emitting diodes LED1, LED2 and LED3 and a motor M, and a sensing element drive and control unit 300 for driving the light emitting diodes and the motor depending on the control signals of the computer 200.

In the configuration, the computer 200 includes an input means 210 such as a keyboard, a mouse, and the like for inputting various operation commands, a CPU 220 for controlling various operations of the computer, a memory 230 for recording various data, a pattern file generating program module 240 for generating a light emitting pattern file for Windows using an audio signal in response to a control command of the CPU 220 and storing the pattern file in the memory 230, a game or various application execution module 250 executed by the CPU 220 if a command for executing a game or various applications is inputted through the input means 210 and calling a function of fetching the light emitting pattern file and the like from the memory in accordance with or independently from the audio signal, a DLL module 260 for receiving a file including the light emitting pattern file and the like outputted from the game or various application execution module 250, and a human interface driver module 270 of Windows for receiving a control signal from the DLL module 260 and outputting the received control signal.

In addition, the sensing element drive and control unit 300 of the electric/electronic device includes a sensing element drive and control CPU 310 for receiving a signal outputted from the computer 200, analyzing details of a light emitting pattern (brightness and duration time) if the received signal is a light emitting pattern, and generating a PWM signal including an identification control signal for identifying a sensing element of the electric/electronic device, together with drive control signals, such as brightness, intensity, duration time, and the like, for driving and controlling the LEDs and the motor M, i.e., sensing elements of the electric/electronic device, and a variable voltage source circuit 320 for driving one or more LEDs 180 and the motor M based on the control signals outputted from the sensing element drive and control CPU 310.

In the meantime, in the configuration described above, the sensing element drive and control CPU 310 receives a pattern file outputted from the main body, i.e., the computer 200, and outputs an operation control signal appropriate to the transmitted pattern file as a PWM signal depending on the type of a sensing element that needs to be driven currently. The PWM signal includes an identification signal for identifying a sensing element to be driven, together with control signals, such as vibration strength, brightness, driving maintain time, and the like, for actually driving the sensing elements. The signals outputted from the sensing element drive and control CPU 310 as described above are outputted to a variable voltage source in series or parallel. At this point, a SEL signal, i.e., an operation selection signal of a switching unit connected between the variable voltage source and the sensing elements, is outputted together, and one or more the sensing elements can be selectively or simultaneously driven.

The steps of generating a pattern file using the computer configured as described above and driving and controlling sensing elements using the pattern file will be described below.

### 1) Generate Pattern File

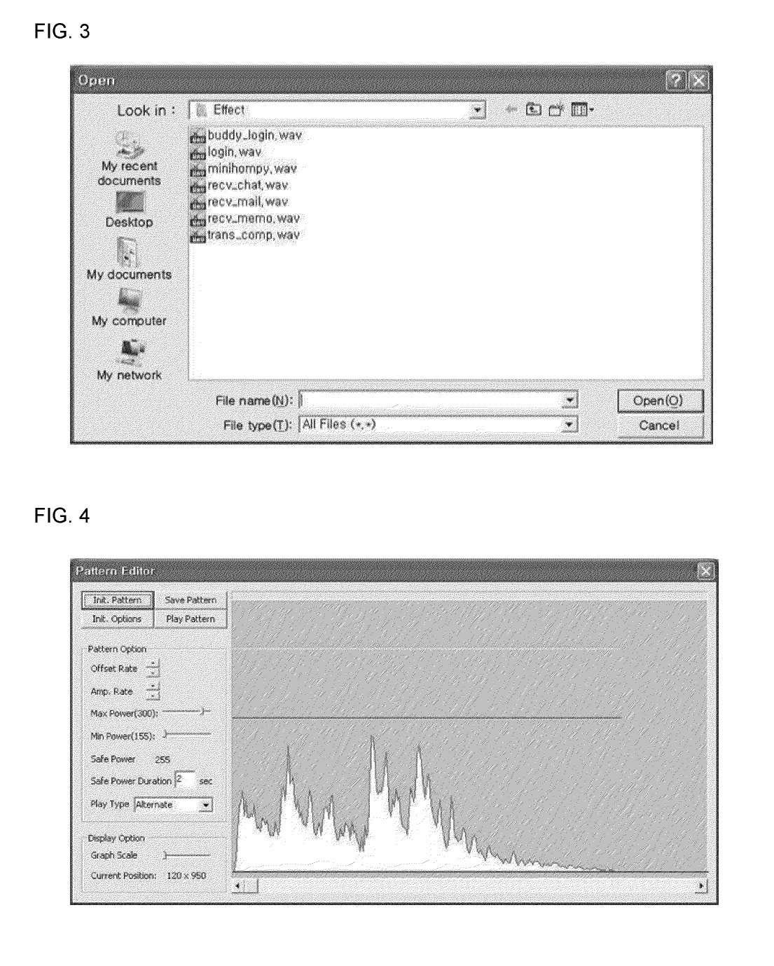

A worker drives the pattern file generating program module as shown in FIG. 2 using the input means such as a keyboard, a mouse, or the like provided in the computer and generates a pattern file by calling an audio signal used in a game or an application as shown in FIG. 3 using the pattern file generating program module. The step of generating and outputting a pattern file is performed in a Window environment so that a general user may control the step, and the pattern file can be repeatedly generated, modified, and deleted using one audio signal in the pattern file generating step depending on a user's selection. For example, a first pattern file is generated by analyzing an audio signal, and various types of light emitting patterns, such as a second or higher light emitting pattern, are generated by adding various types of light emitting patterns to the first pattern file, or modifying or deleting the first pattern file. Then, a light emitting pattern file mostly optimized to the currently generated sounds is generated and stored in the memory of the computer. The pattern file generated as described above has a DAT file structure, which is a data file structure unique to the Windows.

Meanwhile, the step of generating a pattern file will be described hereinafter in more detail.

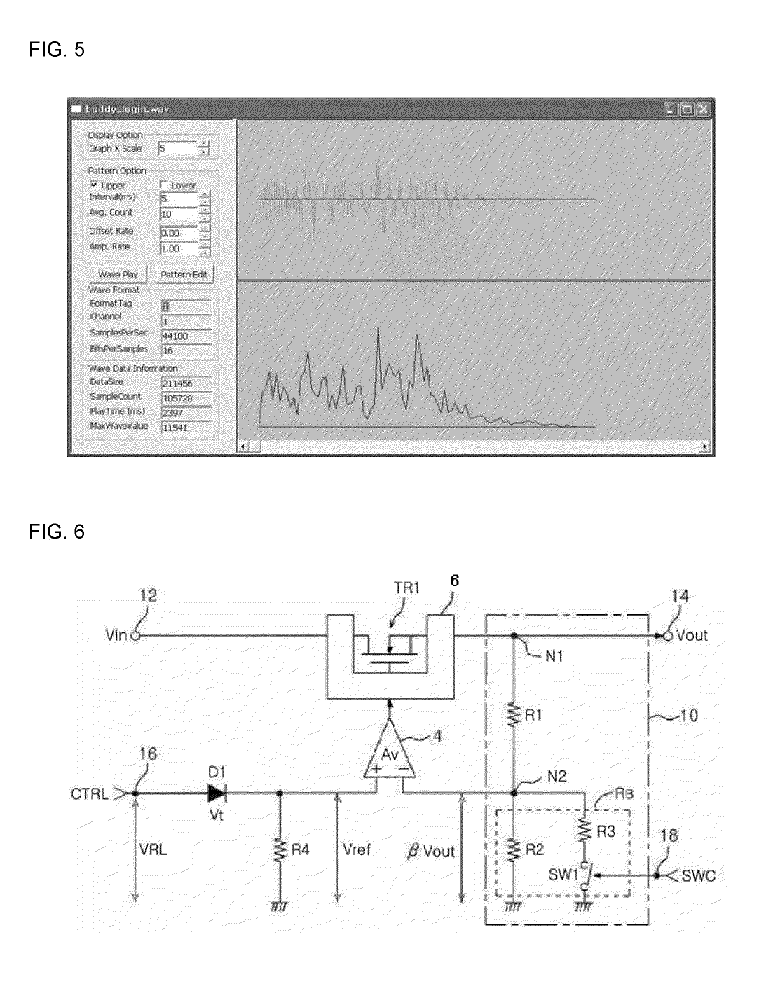

If a user drives the pattern file generating program module and selects an audio signal through the input means, a waveform of the audio signal and a waveform of a pattern file generated by analyzing the audio signal are outputted as shown in FIG. 4. At the same time, a menu for modifying the pattern file (including an interval, a count average, an offset ratio, an amplification rate, etc) is outputted on the Window screen. The user can easily adjust values on a pattern modify menu (a pattern editor) as shown in FIG. 5 using a keyboard, a mouse and the like to modify the pattern file to be suitable for the electric/electronic device that is desired to be used. Since a pattern file corresponding to the adjusted values is displayed on the screen, the user can generate an optimum pattern file while immediately confirming a result of modifying the pattern file through the screen.

Since waveforms of the audio signal and the pattern file are displayed on the screen in real-time by a graphic module, the user can visually and immediately confirm the states of current and modified pattern files, and thus it is easy to generate and modify a pattern file.

The interval in the menu is for generating pattern data from the audio signal at intervals of a set value, and the count average is for generating a pattern file by applying an average of as many data as a set value. The offset rate is for applying an offset to a pattern file at a rate as high as a set value, and the amplification rate is for amplifying a pattern file at a rate as high as a set value.

In addition, the pattern file generated as described above can be modified. A menu including options of an offset rate, an amplification rate, and a maximum power, a minimum power, a safe power, a duration sustaining a safe or higher strength, selection of a vibrating method, and the like according to the electric/electronic device is displayed on the screen, and the user can modify the pattern file by adjusting values of corresponding options using the input means and confirm a result of the modification through the screen.

### 2) Call Pattern File

If a command for executing a game or a variety of applications is inputted through the input means, the CPU of the computer calls a function of fetching the light emitting pattern file generated from a sound source file from the memory in accordance with or independently from the sound source file through the game or various application execution module, and transmits the light emitting pattern file to the DLL module. According to the present invention, only one function needs to be called in this step, and this will be described below in further detail.

A conventional method separately controls hardware and includes at least three steps of calling and executing a function for turning on the hardware, calling and executing software for controlling corresponding hardware, calling and executing a function for transmitting software data, and executing a function for driving the hardware based on the software data.

However, hardware is not separately controlled in the present invention, but software is directly controlled. For example, in a function HID_Write(Level, Time, Mode), the hardware is in an Off state if all of Level, Time, and Mode have a value of zero and in an On state if any one of those has a value of none-zero. In the function, the Level adjusts brightness of 3-color LEDs and can be set to a value ranging between 0 to 255, the Time is a light emitting duration time having a unit of msec and can be set to a value ranging between 0 to 255, and the Mode indicates emission of light and can be set to 0 for Off and 1 for On.

### 3) Transmit Pattern File

The DLL module receiving details of the light emitting pattern transfers a light emitting pattern signal to the human interface driver module (hereinafter, referred to as an HID module) of Windows, and the HID module transfers the signal to the sensing element drive and control CPU.

In the configuration described above, the HID is generally used for automatically recognizing and installing a driver needed when a new apparatus is attached to the computer. When a new apparatus or device is connected to the computer, the computer does not recognize the type of the apparatus, and a company manufacturing the product makes a specification for recognizing the device and installs a driver implementing the specification in the computer to recognize the device. The sensing element driving unit 300 of the present invention also conforms to the specification and automatically recognizes the device driver when the device is attached to the computer.

### 4) PWM Signal and Variable Voltage Source Circuit

The sensing element drive and control CPU of the electric/electronic device receives and analyzes details of the light emitting pattern (brightness and a duration time), generates a PWM signal appropriate to the electric/electronic device, and outputs the PWM signal to the variable voltage source circuit. If 3-color LEDs and a vibration motor are used as is described in the embodiment of the present invention, a PWM signal for the 3-color LEDs and a PWM signal for the vibration motor are generated at the same time using the inputted light emitting pattern file.

Each of the PWM signals generated in this step includes data for identifying a corresponding sensing element and data for driving the sensing element. For the vibration motor, the driving data determines vibration strength depending on the Level of the light emitting pattern file LEVEL, a vibration duration time depending on the light emitting duration time TIME, and a forward/reverse rotation depending on an on/off mode MODE signal, based on the information on the inputted light emitting pattern file.

In addition, the PWM signals generated as described above are outputted to the variable voltage source in series or parallel, and a selection signal SEL for driving the switching unit is also outputted in this step.

### 5) Drive LEDs and Vibration Motor or Actuator

The variable voltage source circuit converts the inputted PWN signals to voltage level signals and adjusts illuminance of the LEDs, strength of the vibration motor or the actuator, and the like, and this will be described below in further detail.

As a first step of modulating an analog signal into a digital signal, the analog signal is converted into 0's and 1's to confirm only the existence of signal, and strength Level of the analog signal is converted into a level between 0 and 255 if the converted digital signal is in a state of 1 where the signal exists, and thus existence and strength of the signal can be obtained. The LEDs (brightness) and the motor (strength and direction of rotation) are driven using the obtained existence and strength of the signal.

There are some cases where the sensing elements (the LEDs and the vibration motor or the actuator) operate in a specific section (100 to 200 among 0 to 255) due to the characteristics of the sensing elements, and the Equation of the strength used in this case is

DEV_{—}W=101(100˜200), DATA_{—}W=256(0˜255),

Level=input signal/DEV_{—}W×DATA_{—}W, and

the vibration motor rotates in a forward direction when the Mode is 0 and rotates in a reverse direction when the Mode is 1, or the state is changed if the duration time is less than 100 msec (0 to 1, or 1 to 0).

In the configuration describe above, a circuit proposed in Korean Patent Registration No. 10-0757242 described in the background art is used as the variable voltage source circuit, and a typical configuration of the circuit is as shown in FIG. 6.

The variable voltage source circuit unit 2 includes an N-channel MOSFET transistor (hereinafter, referred to as a “transistor”) TR1, a diode D1, a resistor R4, an operational amplifier 4, a feedback circuit 10, and an over-current and overheat cut-off circuit 6 for cutting off over-current and overheat of the N-channel transistor TR1.

The transistor TR1 is configured such that an input voltage Vin is applied to the drain of the transistor TR1 through an input terminal 12. The source is connected to an output terminal 14, and an output voltage Vout is outputted from the output terminal 14. A gate control signal outputted from the operational amplifier 4 that compares and amplifies two input signals is applied to the gate.

In FIG. 6 described above, Vref is a voltage applied to a non-inverting input terminal + of the operational amplifier 4, Av is a voltage gain of the operational amplifier 4, and β is a feedback ratio, and the output voltage Vout of the variable voltage source circuit unit 2 can be obtained from Equation 1 shown below.

$$Vout = Vref \frac{Av}{1 + Av β} \qquad Equation 1$$

In Equation 1 described above, if multiplication of the feedback ratio β by the voltage gain Av of the operational amplifier 4, i.e., a value of β*Av, is sufficiently large as to ignore the “1” placed in the denominator of the Equation, the output voltage Vout of the variable voltage source circuit unit 2 can be expressed as Vout=Vref/β, and thus the output voltage Vout can be configured as a constant voltage source in a method described below.

That is, both the control input voltage Vref applied to the non-inverting input terminal + of the operational amplifier 4 and the feedback ratio β of the output voltage Vout fed back to an inverting input terminal − of the operational amplifier 4 need to be set as a constant.

On the contrary, the output voltage Vout is configured as a variable voltage source in a method described below. That is, at least either the control input voltage Vref or the feedback ratio is set as a variable. In other words, if the control input voltage Vref and/or the feedback ratio β is configured as a variable continuously or abruptly varying with time, the output voltage Vout becomes a variable voltage source.

Configuring the control input voltage Vref and the feedback ratio as a variable is described below in further detail.

First, in order to configure the control input voltage Vref applied to the non-inverting input terminal + of the operational amplifier 4 as a variable, a control signal CTRL applied to a control signal input terminal 16 is implemented to vary with time, and a PWM signal is used as a source of the control signal CTRL in the present invention.

Next, in order to configure the feedback ratio β as a variable, the feedback circuit 10 is configured as shown in FIG. 6. The feedback ratio β cannot be implemented to continuously vary due to the characteristics of the circuit.

In the feedback circuit 10, one end of resistor R1 is connected to node N1 placed between the source of the N-channel transistor TR1 and the output terminal 14, and the other end of resistor R1 is connected to the inverting input terminal − of the operational amplifier 4 through node N2. Resistor R2, one end of which is grounded, is connected to node N2, and one end of resistor R3 parallel to resistor R2 is connected to resistor R2. Switch SW1, one end of which is grounded, is connected to the other end of resistor R3. A switch control signal SWC is applied to switch SW1, and the feedback ratio β has two states depending on On and Off of switch SW1.

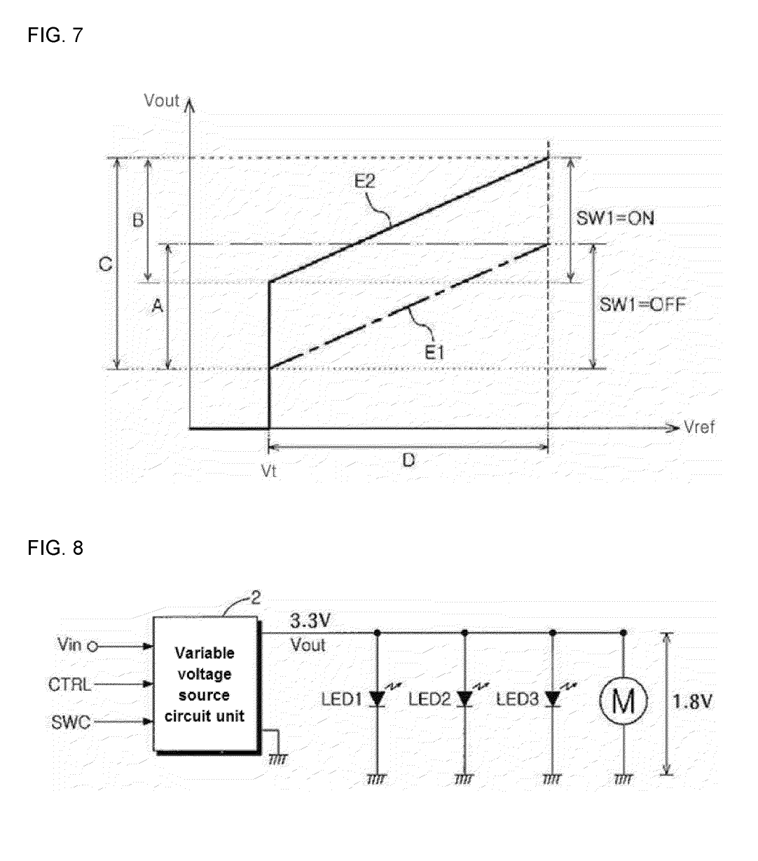

Accordingly, the feedback ratio has two values (first and second feedback ratios), and FIG. 7 shows operating characteristic curve E1 obtained when the switch SW1 in the variable voltage source circuit unit 2 is off and operating characteristic curve E2 obtained when the switch SW1 is on.

FIG. 7 shows a variable voltage input signal range of the control input voltage Vref. Vt is a turn-on voltage of diode D1, which is a reference voltage enabling the variable voltage source circuit unit 2 to operate or not to operate. In addition, the turn-on voltage Vt of diode D1 prevents malfunction of the variable voltage source circuit unit 2 incurred due to a noise or a weak power applied to the control signal input terminal 16. Therefore, the output voltage Vout of the variable voltage source circuit unit 2 is outputted only when the voltage level VRL of the control signal CTRL applied to diode D1 is higher than the diode turn-on voltage Vt.

Output dynamic range C is determined by output dynamic range A of operating characteristic curve E1 and output dynamic range B of operating characteristic curve E2, and output dynamic ranges A and B are overlapped with each other in the middle of output dynamic range C. Output dynamic range A of operating characteristic curve E1 can be overlapped with output dynamic range B of operating characteristic curve E2 by adjusting a value of resistor R3 connected to switch SW1 of the feedback circuit 10 in series.

Therefore, output dynamic range C of the output voltage Vout is extended almost as much as dynamic range A+B.

On the other hand, a signal processing unit, such as a filter or a bias circuit unit, is optionally provided at the front end of the control signal input terminal 16 depending on the characteristics of the applied control signal CTRL. If the source of the control signal CTRL is a PWM signal as is configured in the present invention, a low pass filter (LPF) for removing integration and high-frequency components is provided at the front end of the control signal input terminal 16 as a signal processing unit.

Describing the above-mentioned variable voltage source circuit driving LEDs with reference to FIG. 8, since an input voltage Vin, a control signal CTRL (mandatory), and a switch control signal SWC (optional) are inputted into the variable voltage source circuit unit 2, and the control signal CTRL is a PWM signal outputted from the sensing element drive and control CPU, output voltage Vout is variably outputted depending on a user's definition. Therefore, for example, if the output operating range of the LED is 1.8 to 3.3 V under the control of the switch control signal SWC, the output voltage Vout of the variable voltage source circuit unit 2 is variably outputted within a range of 1.8 to 3.3 V, and brightness of the LED is varied accordingly.

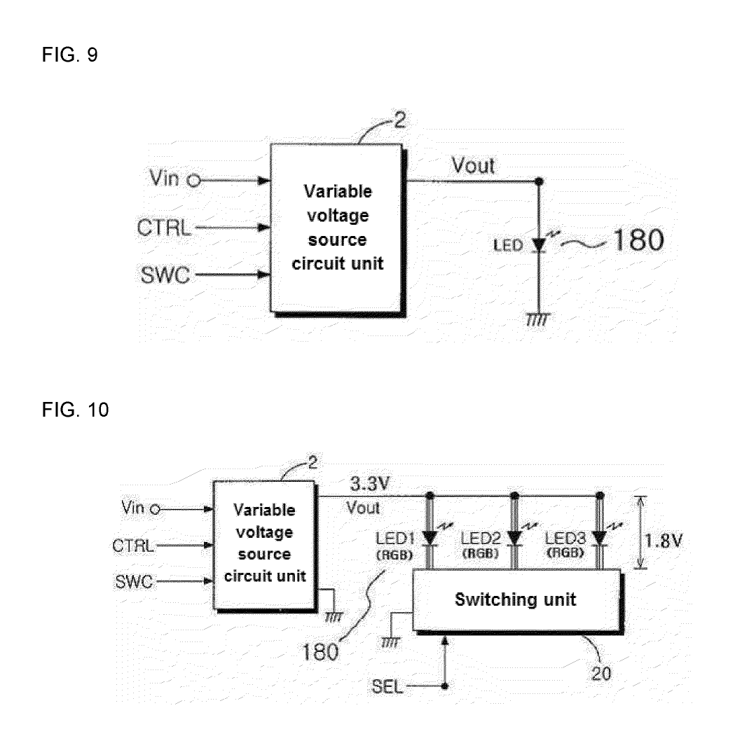

FIGS. 9 and 10 are block diagrams showing an example of driving LEDs according to an embodiment of the present invention.

Referring to FIG. 9, since the control signal CTRL applied to the variable voltage source circuit unit 2 of the LED 180 is a PWM signal, output voltage Vout is variably outputted. For example, if the operating range of the LED 180 is 1.8 to 3.3 V, output voltage Vout of the variable voltage source circuit unit 2 is variably outputted within a range of 1.8 to 3.3 V, and illuminance of the LED 180 is varied accordingly.

FIG. 10 shows an example of driving 3-color LEDs, in which a switching unit 20 using a full bridge circuit is further provided at the rear end of the variable voltage source circuit unit 2. Certain LEDs are selected among LEDs 1 to 3 depending on a logic state of the selection signal SEL outputted from the sensing element drive and control CPU, and current is applied to the selected LEDs.

Although the logic state of the selection signal outputted from the sensing element drive and control CPU will be slightly different depending on the number of switches that can be controlled by the selection signal SEL (generally, 4 to 8), if the number of switches is 4, the logic state will be 000 to 111 as shown in Table 1.

TABLE 1

| Order | On/Off | Switch | State |
|---|---|---|---|
| 1 | 0 | 00 | No. 1 Off |
| 2 | | 01 | No. 2 Off |
| 3 | | 10 | No. 3 Off |
| 4 | | 11 | No. 4 Off |
| 1 | 1 | 00 | No. 1 On |
| 2 | | 01 | No. 2 On |
| 3 | | 10 | No. 3 On |
| 4 | | 11 | No. 4 On |

A value obtained by dividing the Level by the number of controllable switches is used as an order. DEV_C=4(number of SELs), DATA_W=256(0˜255), and order=input signal/DATA_W×DEV_C.

In this case, one input terminal of the full bridge circuit configuring the switching unit is connected to the variable output voltage Vout outputted from the variable voltage source circuit unit 2, and the other input terminal is connected to the ground.

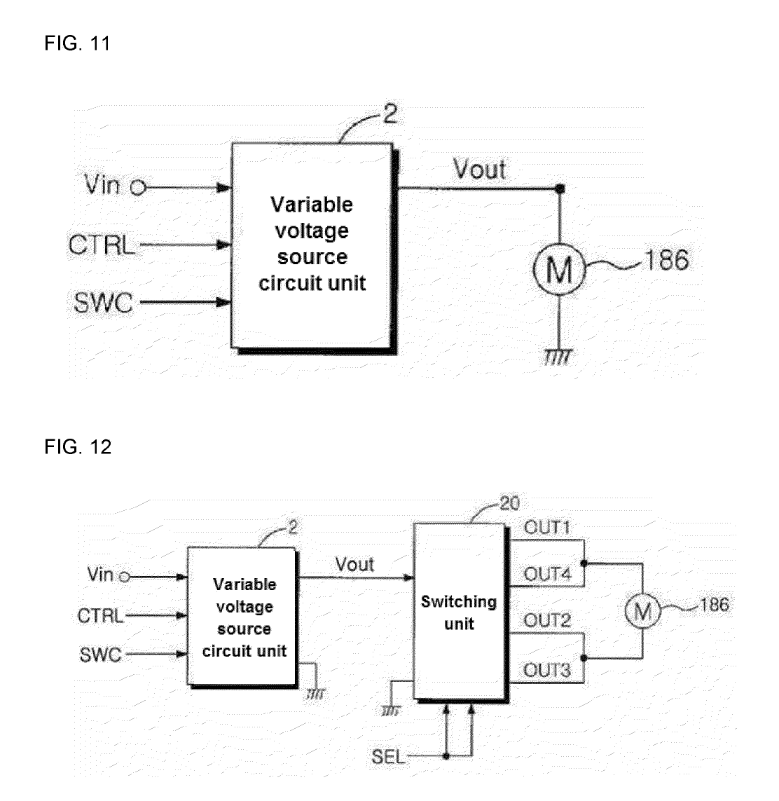

FIGS. 11 and 12 are block diagrams showing an example of a variable driving a vibration motor.

Referring to FIG. 11, the sensing element drive and control CPU outputs a PWM signal for driving the vibration motor based on a light emitting pattern file outputted from the computer, and the variable voltage source circuit unit 2 variably outputs output voltage Vout depending on the control signal CTRL. For example, if the operating range of the vibration motor 186 is 1.8 to 3.3 V, the output voltage Vout of the variable voltage source circuit unit 2 is variably outputted within a voltage range of 1.8 to 3.3 V, and rotating speed of the vibration motor 186 is varied accordingly.

Referring to FIG. 12, a switching unit 20 using a full bridge circuit is further provided at the rear end of the variable voltage source circuit unit 2, and direction of current applied to the vibration motor 186 is changed depending on a logic state of the selection signal SEL, and thus direction of rotation of the vibration motor 186 can be changed. For example, if the selection signal SEL is in a logical ‘high’ state, output signals of the switching unit are outputted through OUT1 and OUT4, and the vibration motor 186 rotates clockwise, and if the selection signal SEL is in a logical ‘low’ state, the vibration motor 186 rotates counterclockwise depending on the signals outputted through OUT2 and OUT3 of the switching unit.

In this case, one input terminal of the full bridge circuit is connected to the variable output voltage Vout outputted from the variable voltage source circuit unit 2, and the other input terminal is connected to the ground.

If a variable voltage source circuit unit 2 having a limited number of output ports is used, the switching unit extends the number of output ports of the variable voltage source circuit unit 2 up to four, and the selection signal SEL for selecting output ports is outputted from the sensing element drive and control CPU.

On the other hand, in the configuration described above, the sensing elements can be provided in the electric/electronic device as one body, or connected to the electric/electronic device through a wired or wireless connection and provided as an external device. The electric/electronic device is a device that can be driven by itself, such as a computer, a game console, a mobile communication terminal, a PDA, a DMB, a digital TV, an IP TV, a navigation device, an MP3 player, an MP4 player, and the like, or the electric/electronic device can be a peripheral device (a speaker, an ear-microphone, a mouse, a keyboard, a remote controller, etc) connected to the electric/electronic device through a wired or wireless connection.

In addition, the sensing element drive and control CPU can be provided in the electric/electronic device as one body or independently from the electric/electronic device, and if the sensing element drive and control CPU is provided independently, it communicates with the electric/electronic device through a wired or wireless connection.

In addition, the variable voltage source circuit also can be provided in the electric/electronic device as one body, independently from the electric/electronic device, or as an external device through a wired or wireless connection.

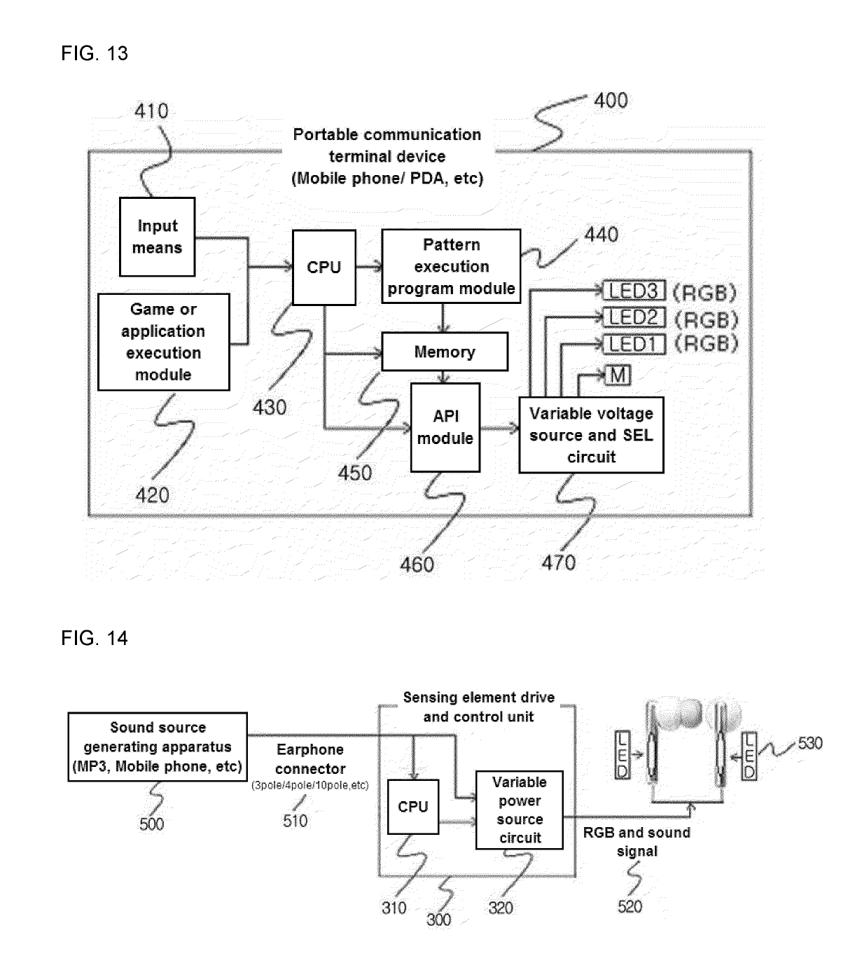

FIG. 13 is a view showing a sensing element drive and control unit provided in a portable communication terminal device, such as a PDA, a cellular phone, or the like among electric/electronic devices, as one body. If a user issues a game or application execution command through an input means 410, a CPU 430 drives a game or application execution module 420. The CPU also controls a pattern executing program module 440 in this step in order to output a pattern file in accordance with or independently from the sounds generated while the game or application is executed, and a variable voltage source circuit and a switching unit 470 drive a vibration motor or an actuator, and LEDs 1 to 3 depending on a signal outputted from the CPU 420 or an API module 460.

FIG. 14 is a view showing a sensing element drive and control unit connected to a sound source generating apparatus 500, which is an electric/electronic device, through a wired or wireless connection and provided as a device external to a earphone or a headset. The sensing element drive and control CPU 310 receives an audio signal and a control signal outputted from the sound source generating apparatus 500 and outputs a PWM signal for driving LEDs 530. Accordingly, the variable voltage source circuit 320 drives the LEDs 530. In this step, an audio signal and an LED control signal are outputted through a separate wired or wireless connection, and a pattern file is outputted from the sound source generating apparatus 500.

It has been describe above that the sensing element drive and control unit shown in FIGS. 13 and 14 or some of its constitutional components can be provided in an electric/electronic device as one body, or connected to the electric/electronic device through a wired or wireless connection and provided as an external device.

On the other hand, although a pattern file for LEDs is generated, and the LEDs, the vibration motor, and the actuator are driven using the pattern file in an embodiment of the present invention, according to the present invention, it is also possible to generate a pattern file for the vibration motor and the actuator and use the pattern file to drive the LEDs. Therefore, regardless of the type of a sensing element used for an electric/electronic device, which is used as a basis for generating a pattern file, a variety of sensing elements of the electric/electronic device can be driven and controlled using one pattern file.

Furthermore, since a user can freely form a pattern file using an audio signal as described above in the present invention, the user can share the generated pattern file with other people in an Internet environment, such as a homepage, a blog, an e-mail, a messenger, or the like, or in a method of wired or wireless file exchange with a counterpart.

Furthermore, the pattern file generating program module and the pattern executing program module are generated as separate modules, and both the pattern file generating program module and the pattern executing program module are provided to only those who desire both of them, or only the pattern executing program module is provided to general users.

1. A method of forming a pattern file for driving and controlling sensing elements of an electric/electronic device, using a system comprising: all kinds of input means including a keyboard and mouse, a touch screen, a touch pad, and a keypad; a CPU for controlling various operations; a memory for recording various data; and a pattern file generating program module for generating the pattern file used for driving and controlling the sensing elements of the electric/electronic device using an audio signal depending on a control command of the CPU and an input signal of the input means, and storing the generated pattern file in the memory, the method comprising:
a module driving step of allowing the CPU to drive the pattern file generating program module depending on the signal inputted through the input means;
a display step of allowing the pattern file generating program module to display a waveform of the pattern file generated by analyzing the audio signal selected through the input means on a screen and simultaneously display a pattern modify menu (including options of an offset rate, an amplification rate, and a maximum power, a minimum power, a safe power, a duration sustaining safe or higher strength, and selection of a vibrating method according to the electric/electronic device);
a modifying step of modifying a waveform graph of the pattern file in accordance with values changed on the pattern modify menu inputted through the input means, and displaying the modified waveform graph on the screen; and
a recoding step of recoding the pattern file as modified above if the modification is completed.

2. The method according to claim 1, wherein the pattern file can be transferred to other electric/electronic devices through a wired or wireless connection or a storage medium to be applied to the other electric/electronic devices.

3. An apparatus for driving and controlling sensing elements of an electric/electronic device using a pattern file, the apparatus comprising:
all kinds of input means including a keyboard, a mouse, a touch screen, a touch pad, a remote controller, a keypad, and the like;
a memory for recording various data;
a pattern file generating program module for generating a pattern file for driving and controlling the sensing elements of the electric/electronic device, from a first pattern file generated based on an audio signal through the method of claim 1 according to an input signal of the input means, using a pattern modify menu (including options of an offset rate, an amplification rate, and a maximum power, a minimum power, a safe power, a duration sustaining safe or higher strength, and selection of a vibrating method according to the electric/electronic device), and storing the generated pattern file in the memory;
a game or various application execution module executed when a command for executing a game or various applications is inputted through the input means, for calling the pattern file generated and stored by the pattern file generating program module from the memory in accordance with or independently from the audio signal;
a central processing unit (CPU) for receiving a file including the pattern file outputted from the game or various application execution module and generating a PWM signal including data for identifying each sensing element of the electric/electronic device in order to drive and control a plurality of sensing elements of the electric/electronic device; and
a variable voltage source circuit for driving and controlling corresponding sensing elements based on the data for identifying sensing elements of the electric/electronic device included in the control signal outputted from the CPU.

4. The apparatus according to claim 3, wherein the CPU is divided into an electric/electronic drive CPU for driving the electric/electronic device and a sensing element drive and control CPU for outputting a control signal to drive the sensing element, and the plurality of CPUs is configured as a single unit, or configured separately so as to be connected to each other through a wired or wireless connection.

5. The apparatus according to claim 4, further comprising a switching unit between the variable voltage source and the sensing element for convenience, and the sensing element drive and control CPU outputting a SEL signal, i.e., an operation selection signal of the switching unit, together with the PWM signal, in order to control outputs of a plurality of output terminals of the switching unit.

6. The apparatus according to claim 3, wherein the variable voltage source circuit 320 comprises a transistor having an input terminal for receiving an input voltage and an output terminal for outputting an output voltage, and an operational amplifier for controlling the transistor by comparing voltage levels of two input signals, in which a feedback circuit selectively varies a feedback ratio of a voltage fed back from the output terminal and applied to one input terminal of the operational amplifier, and a control input voltage corresponding to a control signal variable with time is applied to the other input terminal of the operational amplifier.

7. The apparatus according to claim 3, wherein the signal for driving and controlling the sensing element is configured as a function including an on/off mode, an operating level, and a driving time.

8. The apparatus according to claim 5, wherein the selection signal of the switching unit uses a value obtained by dividing a level by the number of controllable switches as an order.

9. The apparatus according to claim 3, wherein the pattern file can be transferred to other electric/electronic devices through a wired or wireless connection or a storage medium to be applied to the other electric/electronic devices.
